(19) United States
(12) Patent Application Publication
(10) Pub. No.: US 2012/0191366 A1
(43) Pub. Date: Jul. 26, 2012

(54) Methods and Apparatus for Assigning a Meaningful Numeric Value to Genomic Variants, and Searching and Assessing Same

(76) Inventors: Nathaniel Pearson, Somerville, MA (US); Katherine Elizabeth D'Aco, Salem, MA (US)

(21) Appl. No.: 13/355,341

(22) Filed: Jan. 20, 2012

Related U.S. Application Data
(60) Provisional application No. 61/434,592, filed on Jan. 20, 2011.

(51) Int. Cl. G06F 19/22

(52) U.S. Cl. 702/20

(57) ABSTRACT

The present invention relates to methods, apparatus and computer systems for assigning a numerical value to a genotype at a single- or multi-base segment in an individual's genome to denote the presence of a match or a mismatch of a nucleic acid base sequence of one or more chromosomal copies of the segment, as compared to the nucleic acid base sequence at a reference genome segment that corresponds to the segment of the individual's genome. The methods involve assigning a single digit numerical value to the match or the mismatch of each chromosomal copy of the segment in the genome, so that the numerical value assigned to a mismatch is greater than the numerical value of the match. A null symbol is assigned to a no call determination. The assigned numerical values are summed and a total numerical value which is a single digit or a fixed number of digits is obtained. The steps are repeated to create a vector of total numerical values for the segment among the set of genomes, to thereby obtain a segment-specific pattern of genotype match/mismatch between a set of genomes and the nucleic acid base sequence at the reference genome segment. The segment-specific pattern, also referred to as a “diff pattern” can be used to filter or uncover specific trends or sub-patterns across a set of genomes, and more quickly identify genotypic/phenotypic relationships by identifying sites where the distribution of genotypes in the set of genomes relates in a distinctive, causal way to the distribution of a given phenotype among the individuals whose genomes are under study.

### RELATED APPLICATION

This application claims the benefit of U.S. Provisional Application No. 61/434,592 filed Jan. 20, 2011.

The entire teachings of the above application are incorporated herein by reference.

### BACKGROUND OF THE INVENTION

Conventional methods for summarizing patterns of allele-sharing in a set of studied genomes typically 1) encode variants either as International Union of Pure and Applied Chemistry (IUPAC) codes for nucleotides or gaps (i.e., A/C/G/T/-), or as arbitrary alphabetic values denoting match or mismatch to a reference sequence (e.g., A for reference-matching and B for reference-mismatching); and 2) either compare just one pair of individuals per file, or compare more than two individuals by storing at least one column per individual.

Using such conventional methodology to compare the genomes of more than two individual organisms from a given population, it is often difficult to quickly find a set of all genome sequence variants that are distinctively shared by a particular nontrivial subset of those individuals, in a particular configuration of zygosity. Another problem when analyzing genomes involves the difficulty in introducing new genomes to the study after the analysis has begun. Data in such studies is often not easily expandable.

Accordingly, a need exists to convert each site-specific genotype in a genome to a biologically meaningful numeric value that, in a set of genomes, can be used to identify sites with chemically distinct but formally equivalent (for generating hypotheses) variant content, and 2) flexibly and elastically stores data for more than two individuals, without varying the number of columns in a file (thereby keeping it easy to parse), and in a sensible numeric form that lets users quickly find sites with quantitatively similar distributions of variants.

### SUMMARY OF THE INVENTION

The present invention relates to methods, in a computer system, for assigning a numerical value to a genotype at a single or multi-base segment in an individual's genome to denote the presence of a match or a mismatch of a nucleic acid base sequence of one or more chromosomal copies of the segment, as compared to the nucleic acid base sequence at a reference genome segment that corresponds to the segment of the individual's genome. The method involves comparing the nucleic acid base sequence of each chromosomal copy of the segment of the genome, to determine the existence of a match to the nucleic acid base sequence of the reference genome segment, mismatch to the nucleic acid base sequence of the reference segment, or cannot be confidently called. The methods also involve assigning a single digit numerical value to the match or the mismatch of each chromosomal copy of the segment in the genome, wherein the numerical value assigned to a mismatch is greater than the numerical value of the match, to thereby obtain an assigned numerical value for each nucleic acid base of the genotype, and assigning a null symbol to a no call (e.g., lack of a confident determination of match/mismatch) determination. The present invention includes a step of summing the assigned numerical values of each chromosomal copies of the segment in the genome, to thereby obtain a total numerical value for the genotype, wherein the total numerical value is a single digit or a fixed number of digits; and saving, to a database, the total numerical value for the genotype in the genome or the null symbol of a no call determination, with or without a delimiter, for the segment of the genotype in the genome of the individual. The steps can be repeated for each genome in the segment to thereby create a vector of total numerical values for the segment among the set of genomes, to thereby obtain a segment-specific pattern of genotype match/mismatch between a set of genomes and the nucleic acid base sequence at the reference genome segment. In an embodiment, the genotype includes an allele set. In another embodiment, the method utilizes at least two genomes, wherein the two genomes can be from the same individual or from different individuals. In an aspect, a match of the chromosomal copy of the segment of the genome to the corresponding nucleic acid base sequence of the reference genome segment is assigned, for example, a numerical value of 0 and a mismatch is assigned a numerical value of 1, and a no call is assigned a null symbol of “_”; and the total numerical value is not greater than 2.

The present invention also includes methods of filtering one or more segments of two or more genomes, based on a numerical segment-specific match/mismatch pattern between a set of genomes, wherein the pattern is assigned according to the method described herein. Such a method includes the steps of choosing a desired match/mismatch pattern to thereby obtain a target pattern; and comparing the target pattern to the match/mismatch pattern of each segment, to assess segments for which the target pattern is the same as the match/mismatch pattern, or segments for which the target pattern closely resembles the match/mismatch pattern. The method further includes displaying segments for which the target pattern is the same as the matching/mismatch pattern, or segments for which the target pattern closely resembles the match/mismatch pattern, wherein a target pattern that closely resembles the match/mismatch pattern is defined by a distance metric as follows:

$${D}_{AB} = \text{?} \vert {A}_{j} - {B}_{j} \vert$$

$$\text{?} \text{indicates text missing or illegible when filed}$$

wherein pattern Aj is the value in the target pattern for the jth individual's genome, and pattern Bj is the value in the match/mismatch pattern for the segment in the jth individual genome, and n is the total number of individual genomes in the dataset. Variants can be filtered, for example, based one or more additional criteria, wherein each criterion defines a characteristic associated with the genome segment or variants found therein. Examples of criterion defining a characteristic associated with the genome segment or variants found therein include information or status of publications about the variant, if the segment directly assists in encoding a functional molecule, if a variation in the segment or in a larger section containing the segment is a priori thought to help govern the odds of a particular disease or other phenotype, and the like. The match/mismatch pattern can be filtered with a pattern that represents a recessively acting variant, a dominantly acting variant or a loss of heterozygosity (e.g., a match/mismatch pattern represents a genome from a tumor, as compared to another genome from another tissue in the individual).

The present invention pertains to a computer system for assigning a numerical value to a genotype at a single or multi-base segment in an individual's genome to denote the presence of a match or a mismatch of a nucleic acid base sequence of one or more chromosomal copies of the segment, as compared to the nucleic acid base sequence at a reference genome segment that corresponds to the segment of in the individual's genome. The computer system includes a source data comprising one or more genomes having one or more genotypes at a single or multi-base segment wherein the segment has a nucleic acid base sequence of one or more chromosomal copies, and the nucleic acid base sequence of the reference genome segment that corresponds to the segment of the individual's genome. The computer system further includes software, configured to receive and process the source data using the processing unit, wherein the software compares the nucleic acid base sequence of each chromosomal copy of the segment of the genome to determine the existence of a match to the nucleic acid base sequence of the reference genome segment, a mismatch to the nucleic acid base sequence of the reference segment, or cannot be confidently called. The software also assigns a single digit numerical value to the match or the mismatch of each chromosomal copy of the segment in the genome, wherein the numerical value assigned to a mismatch is greater than the numerical value of the match, to thereby obtain an assigned numerical value for each nucleic acid base of the genotype, and assigns a null symbol to a no call determination. The software then sums the assigned numerical values of each chromosomal copies of the segment in the genome, to thereby obtain a total numerical value for the genotype, wherein the total numerical value is a single digit or a fixed number of digits; and saves, to a database, the total numerical value for the genotype in the genome or the null symbol of a no call determination, with or without a delimiter, for the segment of the genotype in the genome of the individual. The software, in an aspect, can be utilized to repeat the steps for each genome in the segment to thereby create a vector of total numerical values for the segment among the set of genomes, to thereby obtain a segment-specific pattern of genotype match/mismatch between a set of genomes and the nucleic acid base sequence at the reference genome segment. Additionally, the software can be configured to assign the numerical value so that a match of the chromosomal copy of the segment of the genome to the corresponding the nucleic acid base sequence of the reference genome segment is assigned, for example, a numerical value of 0 and a mismatch is assigned a numerical value of 1, and a no call is assigned a null symbol of “_”; and the total numerical value is not greater than 2. The computer system can further include an output device providing a display of the match/mismatch pattern.

The computer system further includes a database having the data described herein. In an embodiment, a database includes a genome having one or more genotypes; a single- or multi-base segment for the genotype, wherein the segment comprises a nucleic acid base sequence of one or more chromosomal copies, and a nucleic acid base sequence of the reference genome segment that corresponds to the segment of the individual's genome; and a total numerical value for the genotype, wherein the total numerical value is a single digit or a fixed number of digits, as described herein. The database further includes, in an aspect, data from more than one genome; and a vector of total numerical values for the segment among the set of genomes, to thereby obtain a segment-specific pattern of genotype match/mismatch between a set of genomes and the nucleic acid base sequence at the reference genome segment.

In yet another embodiment, the present invention pertains to a computer system for assigning a segment-specific pattern to each site of a genome, and for enabling a user to search for sites of subject genomes having an identical or sufficiently resemble a target pattern. The pattern is based on a distribution of a match or mismatch between an individuals' studied genome and a reference genome. The computer system comprises one or more processing units and a memory storing a source data comprising one or more genomes having one or more genotypes at a single or multi-base segment wherein the segment comprises nucleic acid base sequences of one or more chromosomal copies of subject genomes and nucleic acid base sequences of corresponding segments in the reference genome. The memory also stores one or more software to be executed by the one or more processors to process the source data. The one or more software includes instructions that, for each segment of genomes includes: 1) comparing the nucleic acid base sequence of each chromosomal copy of the segment of the genome to determine a match to the nucleic acid base sequence of the reference genome segment, a mismatch to the nucleic acid base sequence of the reference segment, or insufficiency of determination; 2) assigning a numerical value to the match or the mismatch determined for each chromosomal copy of the segment in the genome, and a null symbol to a no call determination; and 3) obtaining a total numerical value for the genotype by adding the assigned numerical values of each chromosomal copies of the segment in the genome. In an aspect, the software further comprises instructions for storing the total numerical value for the genotype in the genome and/or the null symbol of a no-call determination to a database. In yet another aspect, the software further comprises instructions for: 1) receiving a desired target pattern from a user; 2) searching for segments in the subject genomes having match/mismatch patterns identical to the target pattern and the segments that closely resembles the target pattern; and 3) presenting the obtained segments to the user, wherein the degree of resemblance to the target pattern is defined by a distance metric.

There are a number of advantages of the present invention. The present invention formally summarizes patterns of variant-sharing at sites in a set of Several wholly or partly sequenced genomes, in ways that let users 1) quickly find sites where patterns of variant-sharing exactly match a pattern expected for phenotype-causal variants under a presumed model of such causation, and which thus harbor candidate variants for studying such causation; 2) quickly find sites whose patterns of variant-sharing do not globally match, but locally match or/and resemble the expected pattern arbitrarily closely enough to plausibly harbor candidate variants under assumptions of experimental error/incompleteness, partial penetrance, and/or causal heterogeneity; 3) quickly find sites whose patterns of variant-sharing match or resemble a newly chosen target pattern, as often and easily as desired; 4) parse resulting files easily, due to the uniformity of column numbers and formats; and 5) easily integrate data from newly sequenced genomes, while keeping files readily parsable and searchable.

### BRIEF DESCRIPTION OF THE DRAWINGS

FIG. 1 is a screen output of a spreadsheet of unfiltered genomic data having rows (each representing a single- or multi-base genome segment (henceforth, ‘site’) in a set of individuals' genomes) and columns containing data associated with the site (e.g., chromosome harboring the site in a reference genome; start position of the site in same reference genome; end position of the site in same reference genome; sequence of the site in same reference genome; diff pattern (core data object in present invention); genotype details for the site in individual genomes; predicted functional effect of observed sequence variation at the site (pred_function); indicator of whether the site is already publicly reported to harbor sequence variation (allelism_published_ind); details on variation at the site (allelisms), count of gene(s) harboring site; name(s) of gene(s) harboring the site; phenotypes associated with observed sequence variation the site; phenotype(s) associated with observed sequence variation in a gene that harbors the site; and functional class of observed sequence variation in site, such as missense, nonsense, frameshift, synonymous etc.). The diff pattern column is column H.

FIG. 2 is a screen output of a spreadsheet of the genomic data shown in FIG. 1, but showing the last 50 rows of the dataset, totaling more than 10500 site-specific rows. The diff pattern column is highlighted.

FIG. 3 is a screen output of a spreadsheet of the genomic data shown in FIG. 1 and a filtering box ready to search for a diff pattern equal to [111] is shown.

FIG. 4 is a screen output of a spreadsheet of the genomic data shown in FIG. 1, but showing about 600 or so rows having a diff pattern of [111].

FIG. 5 is a screen output of a spreadsheet of the genomic data shown in FIG. 1 and a filtering box ready to search for a for protein function effect prediction ‘FUNCTION CHANGING’ OR FUNCTION CHANGING *’ (latter denoting less confident prediction than former).

FIG. 6 is a screen output of a spreadsheet of the genomic data shown in FIG. 1, but showing 26 site-specific rows, each having a diff pattern of [111] and within a gene that encodes a protein whose function is predicted to be significantly affected by sequence variation at the site. The diff pattern search and protein filtering reduced the number of possible sites from over 10000 to 26.

FIG. 7 is a screen shot of the KnomeDiSCOVERY SiteSeeker tool, also referred to as knomeVARIANTS tool, which used to search diff patterns and perform distance metrics on the data. The columns include the following subject genomes: SG1001; SG1002, SG1003, SG1004, SG1005, SG1006, SG1007, SG1008, SG1000, SG1010, EX001, EX002, EX003, and EX004 and the following rows: prefer, also accept, overall search, and leeway.

FIG. 8 is a block diagram showing a computer system and components thereof in accordance with an embodiment of the present invention.

FIG. 9 is a schematic depicting a process flow of software in accordance with an embodiment of the present invention.

### DETAILED DESCRIPTION OF THE INVENTION

A description of preferred embodiments of the invention follows.

The present invention relates to methods and systems that assign a numerical value to a genotype (combination of one or more alleles, i.e., distinct nucleic acid sequence variants) at a site in an individual's genome, based on comparison to the nucleic acid sequence at the corresponding site in a reference genome. By assigning a specific value to the genotype that characterizes match and/or mismatch to the reference genome, a numerical or quantitative pattern of matches and mismatches is created. The pattern, using the steps of the present invention, allows one to readily search for and detect differences and similarities among a set of genomes being studied. The pattern can be used to filter or uncover specific trends or sub-patterns across a set of genomes, and more quickly identify genotypic/phenotypic relationships by identifying sites where the distribution of genotypes in the set of genomes relates in a distinctive, causal way to the distribution of a given phenotype among the individuals whose genomes are under study. Additionally, the unique structure of the data created by the pattern of the present invention allows the database to be expanded and reanalyzed to solve different problems or add genomic data to the database. A segment, as used herein, is defined as a tract of zero or more nucleic acid bases at a known position within a genome, wherein the segment can be, in an embodiment, a single- or multi-base segment having one or more chromosomal copies of a nucleic acid base.

Before the present invention, when comparing the genomes of more than two individual organisms from a given population, it was difficult to quickly find the set of all genome sequence variants that are distinctively shared by a particular arbitrarily chosen subset of those individuals, in a particular configuration of zygosity (e.g., the number of copies of each such variant found in each such genome), and perhaps by other individuals whose genomes are later added to the study.

However, the present invention solves this problem. The present invention includes a method in which the software encodes the variant found for each copy of a chromosome of a given site in the genome of each of k studied individuals as either 1) matching the sequence of the equivalent site in a chosen reference genome (e.g., shared by all genomes under study); 2) mismatching that reference genome sequence; or 3) not confidently called. The present invention includes a step of determining the number of reference-mismatching. variants that were found at each site in each individual genome. The methods of the present invention also involve concatenating the tallies for a given site in a standard, arbitrary order to make a k-length vector that summarizes the distribution of reference-matching and reference-mismatching variants at that site in the set of k studied individuals. For a set of diploid organisms (such as people), each such vector comprises k characters, each of which is either a digit ‘0’, ‘1’, ‘2’, or a value-unknown indicator (such as ‘_’). Sites in hemizygous genome sites, such as a sex chromosome, can be encoded to reflect the likely functional equivalence of a single hemizygous (i.e., in a genome segment that is present in only one copy in a given individual) variant to a homozygous (i.e., in a genome segment that is present in two (or more, for polyploid genomes) identical copies in an individual) variant at the same site.

A transformation distance between any two site-specific vectors (inversely proxying their mutual similarity) can be computed by summing the arithmetic differences between corresponding jth digits in the two vectors, over j from 1 to k (with each position that harbors at least one no-call indicator adding an uncertainty of 2 to the distance, for diploid organisms, unless the no-call indicator represents a case where the variant present at one copy of a site in a given individual, but not another copy in the same individual, is known, in which case the increment of uncertainty may be less than 2). Such a distance metric lets users quickly and flexibly search for all sites whose vectors either perfectly match, or arbitrarily closely resemble, a target vector representing the distribution of some phenotype of interest (or some other known or expected distribution of attributes among the studied individuals), allowing for knowledge of inheritance mode (such as dominance and/or penetrance of allelic effects on phenotype) as well as for partial penetrance, etiological heterogeneity, errors of genotyping or phenotyping, and so forth.

Vectors at multiple sites can be stored together as matrices, allowing more complex searches (such as for matrices comprising multiple rows with matching, similar, or complementary distributions of digits). Knowledge of kinship degree among individuals can be taken into account in formulating target vectors. The underlying data can be queried by a graphical user interface, further described herein, that precisely defines target vectors and individual or vectorwide tolerances based on user-specific knowledge of studied genomes.

In particular, the present invention assigns a pattern to each site of a genome wherein the pattern is based on a distribution of match and/or mismatch between individual studied genomes and a reference genome, and a distance measure can be performed to precisely assess similarities or differences between patterns. Accordingly, the present invention is also referred to herein as a “diff pattern”. More specifically, a diff pattern minimally comprises an n-length string (e.g., contained within distinctive characters that are not part of the pattern itself, such as square brackets) that specifies a pattern of reference-mismatching allele content in all n subject genomes under study. The jth position in the pattern string gives the effective number (for organisms with diploid genomes, 0, 1, or 2; ‘_’ denotes an incompletely called genotype, e.g., containing one or more ‘N’ characters) of reference-mismatching alleles carried by the jth subject.

Match/mismatch between subject genome alleles and reference allele is defined singularly for the whole site from the beginning of the segment (e.g., referred to as “allelism_start” to the end of the segment (e.g., referred to as “allelism_end”) as coordinates; that is, for multi-base allelic sites, a subject genome allele either fully matches the reference sequence (in which case it is counted as reference-matching) or somehow mismatches the reference sequence (in which case it is counted as reference-mismatching). In the diff pattern data, subject genome genotypes comprising one reference-matching and one reference-mismatching allele are encoded as 1; and subject genome genotypes comprising two reference-mismatching alleles (whether homozygous or compound heterozygous) are encoded as 2. In hemizygous genome sites (e.g., mitochondrial, Y-specific, and male X-specific segments), single reference-mismatching alleles each are encoded as 2, reflecting their likely functional equivalence to homozygous mismatches in (pseudo) autosomal or female X-specific regions.

The methods of the present invention include methods for searching for novel associations between genotype and phenotype. A user searching for novel genotype-phenotype association can calculate an expected allelic incidence pattern analogous to the diff_pattern, if the user a) knows which studied subject genomes show a particular phenotype, b) knows or assumes some pattern of causal allele inheritance of that phenotype (e.g., dominance or recessiveness). The user can then search for sites where diff_pattern matches or sufficiently resembles the expected pattern. For such searches, difference between two n-length patterns, pattern A and pattern B, can be measured as a simple transformation distance:

$${D}_{AB} = \text{?} \vert {A}_{j} - {B}_{j} \vert$$

$$\text{?} \text{indicates text missing or illegible when filed}$$

where A-sub-j (vs. B-sub-j) is the value at the jth position in pattern A (vs. B), and so forth (care should be taken with patterns that contain one or more ‘_’ characters, as distance measures for such patterns can be calculated only with uncertainty). Such transformation distances let the user identify and sort, by similarity, clusters of similar diff patterns, to allow for discrepancies between expected (i.e., phenotype incidence) patterns and candidate site-specific diff patterns (reflecting genotyping error, incomplete penetrance, and/or genetic heterogeneity in phenotype cause).

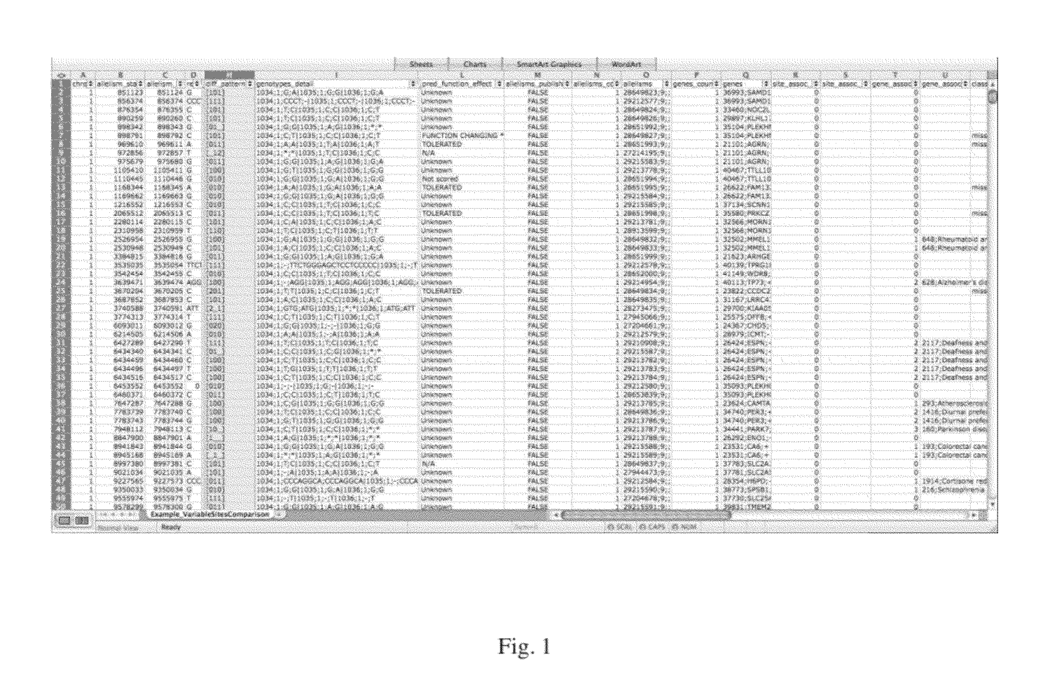

FIG. 1 shows a screen shot of a spreadsheet with diff pattern data. Column H shows sample diff pattern data for 3 genomes. Each number in the diff pattern represents data for an individual genome. Each row of the spreadsheet represents a specific position/site of a genome and each column of the spreadsheet provides information about the nucleic acid base at that site. In addition to the diff pattern, examples of data stored for information about a particular site of a genome include, positional information (chromosome number, position on the chromosome), the nucleic acid base at the position for a genome, the nucleic acid base of the reference genome, information about variants at that position, function or phenotype associated with that variant, associated sites, etc. In the example shown in row 2 (Chromosome 1, position 851123), the reference genome has a “G” or a Guanine (column D) and the three genomes assessed have the following pairs of alleles/bases: Genome #1034 has a G and an A (Adenine), Genome #1035 has a G and a G, and Genome #1036 has a G and an A (See Column I). When comparing allele set to the reference genome, as described above, a match is a 0, a single mismatch is assigned a “1” and if both alleles mismatch, the diff pattern is assigned a “2”. In this specific example, for Genome #1034, the diff pattern is a 1 because only one of the alleles, G and A, match the G base of the reference. For Genome #1035, both alleles are the same as the reference (i.e., a “G”), and so the diff pattern is a 0. Finally, for Genome #1036, there is one mismatch for allele set G, A, as compared to the reference and the diff pattern of 1 is assigned. Accordingly, the diff pattern [101] is shown. In the case of a hemizygous genome, only one allele instead of a pair of alleles is assessed and assigned a diff pattern. In this case, since the single mismatch has the same phenotypic manifestation as a double mismatch for a pair of alleles, the single mismatch is assigned a “2” and a single match is assigned a “0”.

In an embodiment, the diff pattern is non-delimited data. The data does not need to be delimited, because, for diploid genomes (and polyploid genomes less than decaploid) a single digit can represent the extent of the mismatch for all alleles at a site; non-numeric characters could be used to extend the utility of non-delimited diff patterns even to polyploidy organisms that are nonaploid or greater, though calculations on such diff patterns would require parsing hex-coded or similarly non-decimal numerical values. Quantifying the extent of the mismatch allows one to numerically assess the mismatches for the particular genome being studied, as well as quickly assess patterns across a set of genomes. The non-delimiting data set used with the present invention, in an embodiment, provides a compact way to store data and the option of expanding the dataset with new genomes. The diff pattern data can be concatenated to accommodate additional genomes. Additionally, the database structure allows one to filter data to find genome segments plausibly causally associated with certain phenotypes. Also, by quantifying the nature of the mismatch of the allele set, distance measure or other metrics can be performed on the data.

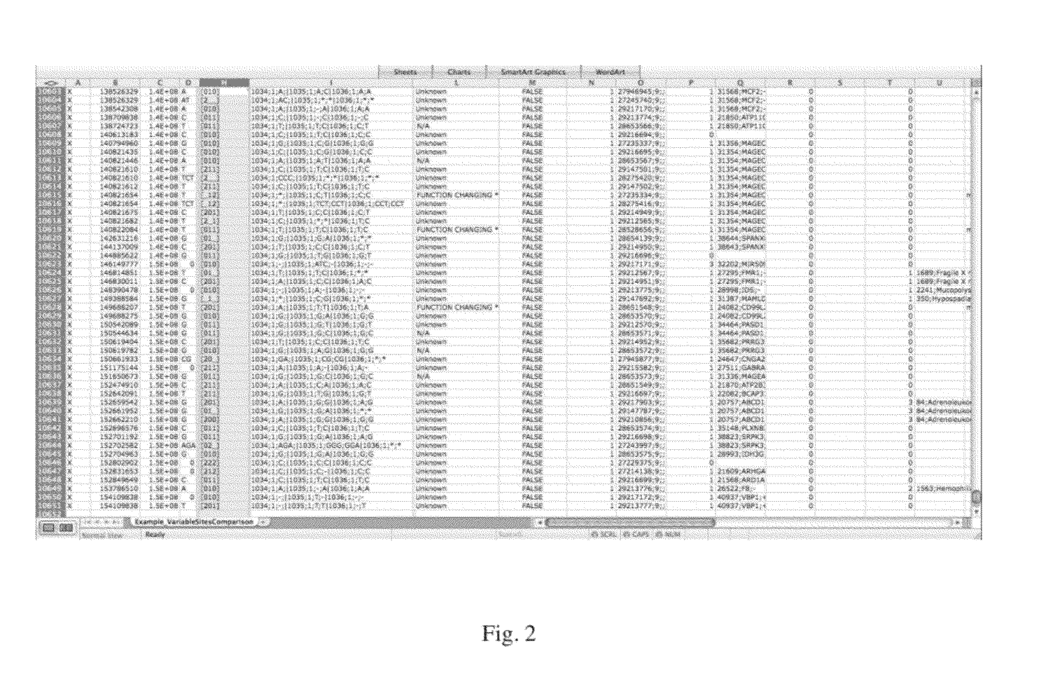

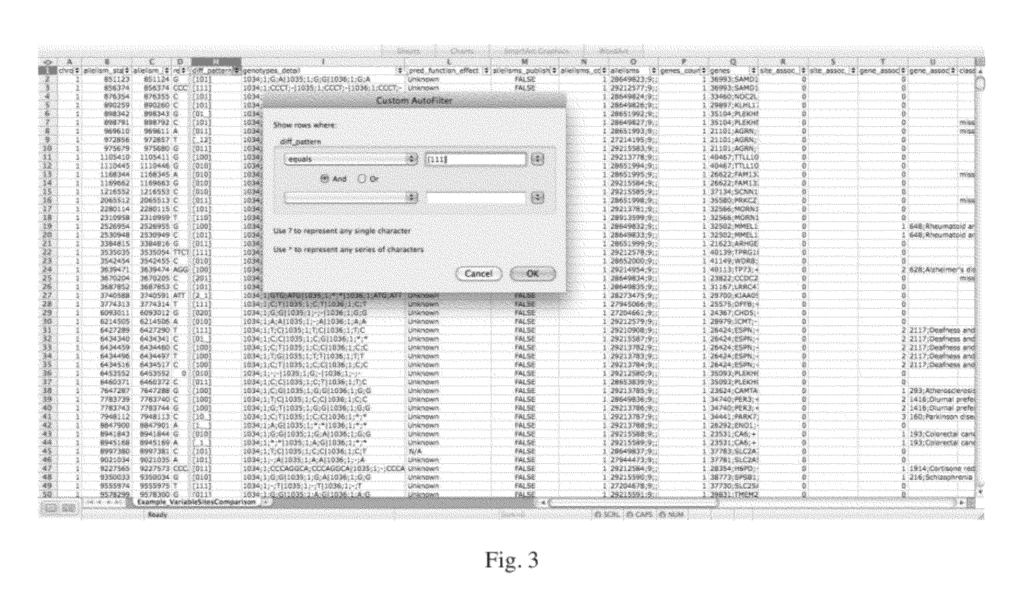

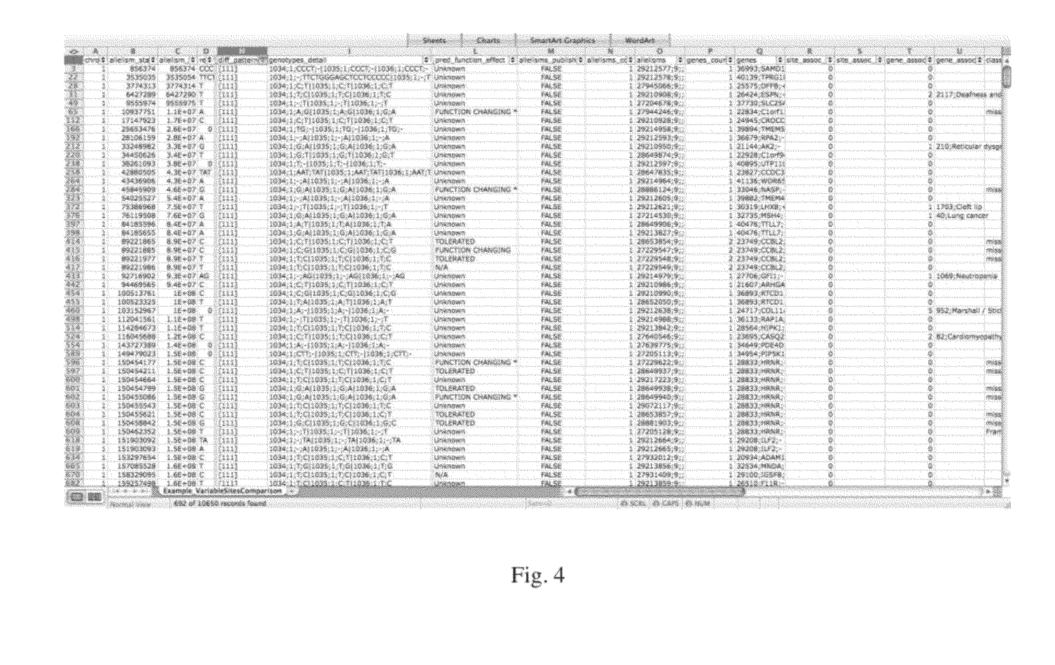

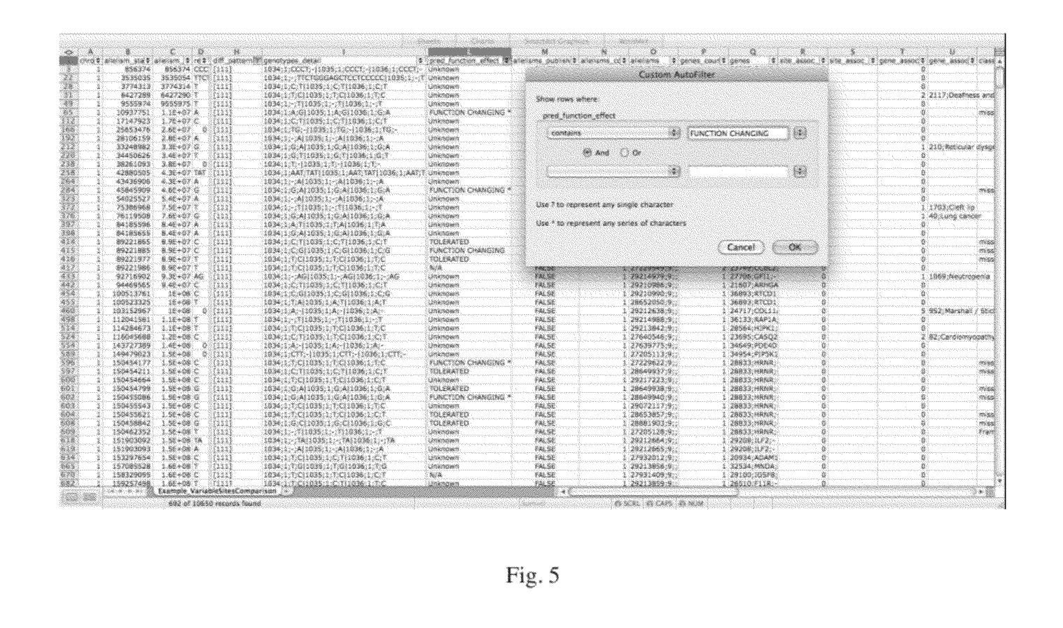

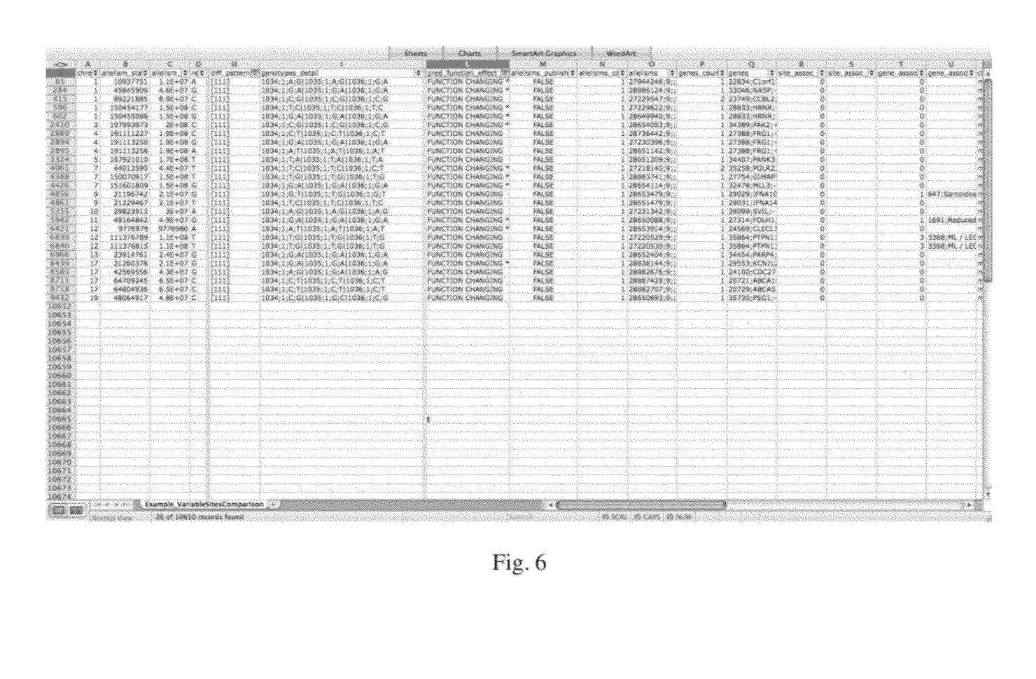

The screen shots shown herein use a basic data filter function; however, customized filter interfaces can be built to more robustly examine and display the data. FIGS. 1-5 show filtered data of a 3-genome comparison file, which has a short diff pattern, looking first for which of ˜10600 sites of novel variants in the study show a pattern fully consistent with a rare, dominant causal variant in a study of 3 affected people. FIG. 1 shows the first 50 or so sites of novel variants, and FIG. 2 shows the last 50 sites of novel variants (i.e., records 10603-10652). The user can filter the genomic sites based on a specific diff pattern or pattern of mismatches. In FIG. 3, the user filtered the data to show diff patterns of [111], namely, to display novel variants having exactly one reference-mismatching allele in each genome. That initial search/filter turns up 600-odd sites, as shown in FIG. 4. The user can then further filter using other information in the database. As shown in FIG. 5, the user filters further by looking for sites with variants that are predicted to significantly affect the function of any protein (e.g., a protein made by whichever gene could harbor the site in question), and end up with just 26 sites in the end (FIG. 6). Specifically, FIG. 5 shows a filtering box, in which the user filters for protein function effect prediction, namely, “FUNCTION CHANGING” or “FUNCTION CHANGING *” wherein the latter denotes less confident prediction than the former. In this case, the diff pattern allows one to start with more than 10,000 sites and narrow down to 26 sites that might readily explain the phenotype of interest. The latter filter is just an example of the kinds of filters that can be combined with the diff pattern, to quickly shortlist interesting variants in the genome. This powerful and robust tool allows a user to filter and search genomic data easily to solve a problem or answer a question. The results of filtering on particular fields depend on the chosen values and data sets. In an embodiment, the user can perform diff pattern searches that filter the file down by more than the ˜15-fold, as shown in this example.

Other applications can be used for the diff pattern data of the present invention, as follows.

### Case 1) Finding a Recessive Disease Allele in a Small Kindred

Assume the diff pattern represents five subject genomes, respectively from two healthy parents, a healthy child, and two sick children. A researcher looking for a recessive disease-causing variant would search first for sites with diff pattern [11022] or [11122], and second for sites with similar patterns containing at least one underscore (‘_’) character, e.g., [1_{—}022], meaning that the variant(s) carried at the site in the genome in question were not reliably called during sequencing.

### Case 2) Finding a Dominant Disease Allele in an Extended Kindred

Assume the diff pattern represents four subject genomes, respectively from a sick parent, a sick child, a healthy child, and a sick first cousin of the parent. A researcher looking for a novel dominant disease-causing variant would search first for sites with novel variants and diff patterns [1101]; second for sites with similar patterns containing at least one underscore (‘_’) character, e.g., [1_{—}01], meaning that the variant(s) carried at the site in the genome in question were not reliably called during sequencing; and third for sites with other patterns similar to the expected pattern (allowing for sequencing errors, genetic heterogeneity of disease etiology, incomplete penetrance, poor phenotyping, and other such error components).

### Case 3) Finding Loss of Heterozygosity in a Tumor

Assume the diff pattern represents two subject genomes, respectively from a tumor and other tissue from the same cancer patient. A researcher looking for sites where the tumor may have lost heterozygosity (by losing or gaining one or more copies of a site of the genome, as the tumor cells divided and spread) would look mainly for sites with diff pattern [10] or [12]—and would pay special attention to spatial clusters of such sites (as defined by chromosome/position information in the file).

Also, the present invention can use a sophisticated graphical user interface for users to search for patterns. Additionally, searches for closely related patterns can be carried out. For example, using the character ‘+’ to mean ‘any positive number, i.e., 1 or 2’ (as in, search for [111+] to mean search for [1111] or [1112]); the character ‘b’ to mean ‘any binary digit, i.e., 0 or 1’; ‘e’ to mean ‘any even digit, i.e., 0 or 2’; etc. Alternatively, the present invention could rely on established regular expression syntax for this, or use well designed standard input prompts to get the relevant search criteria from users.

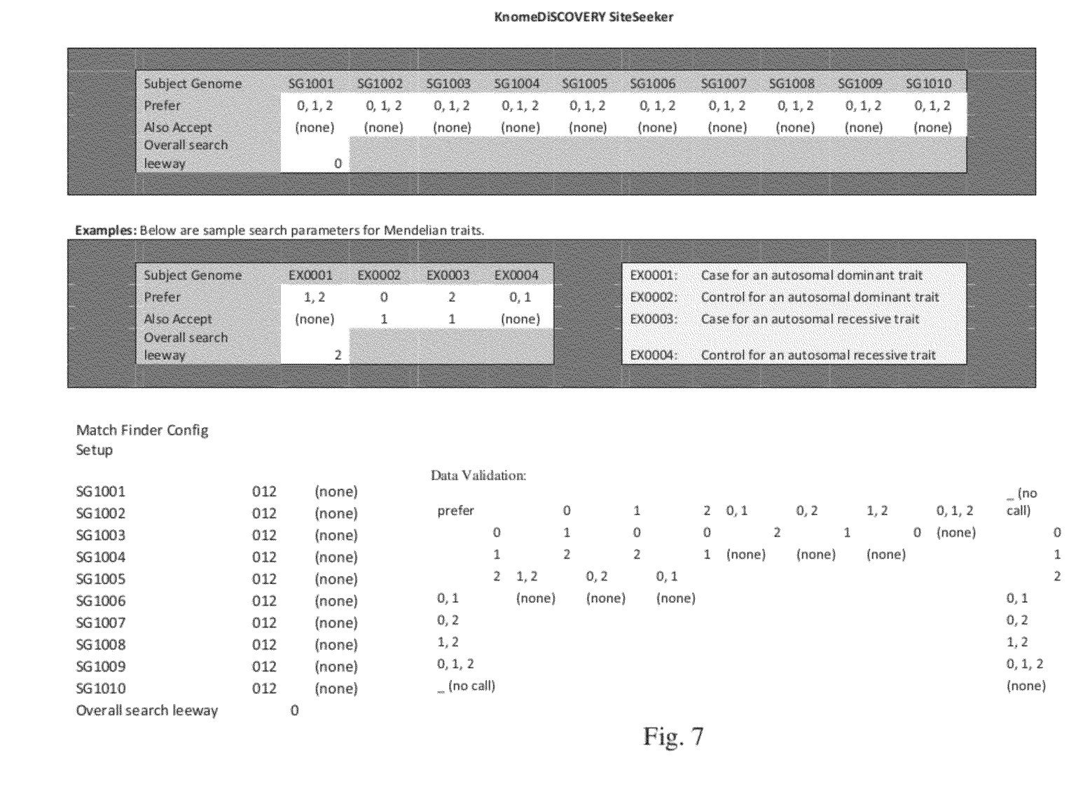

FIG. 7 shows a display, referred to as KnomeDISCOVERY SiteSeeker software, that allows the user to find sites with a specified diff pattern. The software of the present invention helps a user quickly find sites that show particular patterns of variant-sharing among the studied genomes. In particular, the software allows a user to set parameters for the search. To use the software, the user can pick the desired target value(s) (list delimited by commas) expected for each subject genome (SG####) by a pull-down selector in the “Prefer” row, based on a presumed model of allelic effects (e.g., dominant or recessive, taking into account which subject genomes represent “affected” individuals and which represent “controls”). In the “Accept” row, a pull-down selector exists to pick all values that the user will accept (if not prefer) for each subject genome. This feature helps one find sites where the pattern of variant-sharing resembles, but doesn't exactly fit, the presumed/preferred model, because of sequencing errors, genotyping errors, partial penetrance, genetic heterogeneity of etiology, and so forth. Note that a user can copy and paste patterns to quickly fill in parts of the table. In the “Overall leeway” box, the pull-down selector is used to specify the greatest acceptable difference between the target pattern (the set of values in the ‘Prefer’ row) and patterns for sites found in the search (the difference between two patterns is computed as the sum of differences between values (see below) for corresponding subject genomes, summed over all the subject genomes).

Target values: A target value of 0 will find sites where the subject genome shows a homozygous reference-matching variant; a target value of 1 will find sites where that subject genome shows one heterozygous reference-mismatching variant; a target value of 2 will find sites where that subject genome shows a homozygous reference-mismatching variant, or (rarely) two heterozygous reference-mismatching variants; and a target value of _ will find sites where that subject genome was not confidently called. Sites in hemizygous regions (such X or Y chromosome-specific sequence in males, or mtDNA in both sexes) are encoded as homozygous by default; that is, a mitochondrial site showing a reference-mismatching variant is encoded as 2 (unless the site is called as heteroplasmic). The composite diff patterns, used in SiteFinder of FIG. 7 contain commas and latter compactly denote several diff patterns at once. That is, ‘0,1 0,1’ denotes four diff patterns at once, as shown in FIG. 7, as compared to the format described herein that described a single diff pattern (e.g., [00], [01], [10], [11]), and so forth.

Table 1 illustrates an example.

| | | | | | |
|---|---|---|---|---|---|
| settings: | Sg # | 10 | 11 | 12 | 13 |
| | prefer | 0.1 | 0.1 | 2 | 0 |
| | accept | 2 | 2 | | 2 |
| | overall | 4 | | | |
| | search | | | | |
| | leeway | | | | |

| | | | | | | | distance | | |
|---|---|---|---|---|---|---|---|---|---|
| | | | | | | if in also- | between | | |
| | | | | | | accepted, | diff | | |
| | | | | | | list of all | character | | |
| | | | | | | distances | and | | |
| | | | possible | in | in also- | to a | genome- | | |
| | | | unambiguous | preferred | accepted | number in | specific | min | max |
| | Genome # | diff character | diff characters | set? | set? | preferred | target | distance | distance |
| sample | SG10 | 2 | 2 | no | yes | 1, 2 | 1 | 1 | 1 |
| calculation for | SG11 | 1 | 1 | yes | no | na | 0 | 0 | 0 |
| diff_pattern | SG12 | 0 | 0 | no | no | na | 5 | 5 | 5 |
| 210_{—} | SG13 | — | 0 | yes | no | na | 0 | 0 | 5 |
| | | | 1 | no | no | na | 5 | | |
| | | | 2 | no | yes | 2 | 2 | | |
| | | | | | | | total | 6 | 11 |

Referring to Table 1, the target pattern contains two disjoint sets of numbers from the set (0,1,2) for each position of the diff_pattern: the preferred set, which is a list of one or more digits (k digits) and/or uncertainty-code characters, where k is the number of genomes in the set being queried. An example of an uncertain-code or null value is the character “_”. The “also-accepted” set is a list of k digits, uncertainty-code characters, and/or whitespace delimiter characters. Each whitespace delimiter character would represent an individual genome for which only the preferred value(s) is/are to be accepted. The meaning of the sets is described herein. To test if a given diff pattern is sufficiently close to the target pattern, a distance, as defined herein, is calculated.

The distance between a diff pattern and the target pattern is the sum of the distances between the character at each position of the diff pattern and the corresponding character in the target pattern, calculated as described below.

To account for uncertainty in the diff pattern (ie, “_”), a minimum and maximum distance is calculated between each diff pattern and the target pattern, which is found by enumerating each possible value from the set (0, 1, 2) for each “_” in the diff pattern and finding the largest and smallest difference between any corresponding value in the target pattern and each of these numbers.

Note that for diff patterns with no uncertainty codes, the maximum and minimum distances will be equal to each other. The distance between a character and its corresponding target pattern is defined as follows:

$$\begin{matrix} = 0 if the character is a member of the preferred set , \\ = minimum numeric distance between the character and \\ a member of the preferred set if the character is a \\ member of the accepted set ; \\ = total search leeway + 1 if the character is a member \\ neither of the preferred set nor the accepted set .\end{matrix}$$

If the minimum distance between the diff pattern and the target pattern is less than or equal to the total search leeway'set by the user, the variant that is represented by this diff pattern is included in the list of candidate variants.

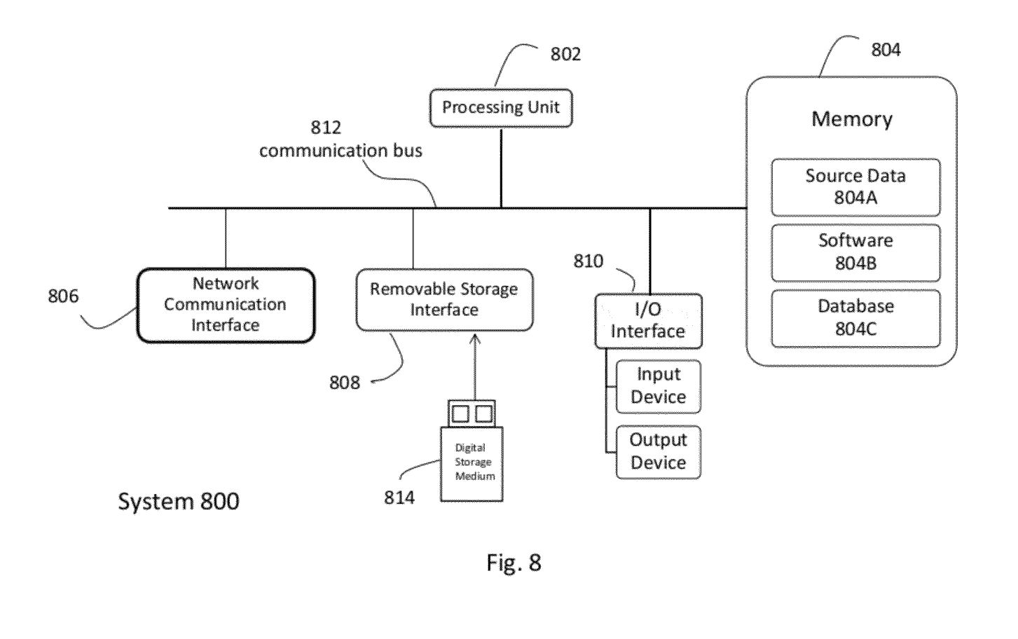

In an embodiment, the present invention also relates to a computer system or computer apparatus to carry out the methods described herein e.g., for assigning, searching and filtering the diff pattern, and/or providing an output of the same. FIG. 8 illustrates an embodiment of a computer system 800, which can implement the methods described herein. The system 800 includes one or more processing units (CPU) 802 and a memory 804. The system 800 also includes a variety of data communication interfaces, such as a network communication interface 806 (e.g., wired or wireless) and a removable storage interface 808, for transferring data from and/or to other systems or data sources. The system 800 further includes input/output interface (I/O Interface) 810 for providing user interfaces for entering user inputs such as search/filter criterions, and for providing outputs such as screen displays and/or printouts. A communication bus 812, directly or indirectly, interconnects all of the components in the system 800.

The processing unit 802 can be a single processor or a plurality of processors, and each processing unit can have one or more processor “cores” to carry out functions, methods, and routines of instructions in accordance with the present invention described herein. The memory 804 can include a main memory such as a volatile memory, (e.g., high speed random access memory (RAM)), or a non-volatile secondary memory such as one or more magnetic or optical storage disks. In an embodiment, the memory 804 can also include mass storages that are remotely located from the system 800 (e.g., cloud storage).

The memory 804 can store the source data 804A (e.g., subject genome data, reference genome data). As described herein, the diff pattern methods and systems of the present invention use an individual's genetic information. To obtain an individual's genetic information, a sample (e.g., blood, saliva, semen, serum, urine and other cellular material) containing deoxyribonucleic acid (DNA) is taken from the individual. DNA is genetic information that is stored in sequences made up of four chemical bases: adenine (A), guanine (G), cytosine (C), and thymine (T). Generally, one copy of the human genome consists of about 6 billion bases (two copies of a ˜3 billion-base haploid sequence, making a diploid genome), and more than 99 percent of those bases are thought to be the same in all people. The sample is prepared and the DNA is extracted from the cells and processed, according to commercially acceptable protocols. Sequencing can be done by a laboratory using high-throughput sequencing platforms. Examples of genomic sequencers include the 454 Genome Sequencer FLX (454 Life Sciences/Roche Applied Science, Branford, Conn., USA), the Illumina Genome Analyzer, powered by Solexa® (Illumina, Inc San Diego, Calif., USA) and the SOLiD TM system (Applied Biosystems by Life Technologies, Carlsbad, Calif. USA), HeliScope TM single molecule sequencer (Helicos BioSciences Corporation Cambridge, Mass. USA) and CEQ TM 8000 (Beckman Coulter, Inc. Brea, Calif. USA). Sequencing techniques known in the art or later developed can be used with the methods and systems of the present invention. To increase the rate at which the DNA is sequenced, the DNA is digested and sequenced in smaller pieces and then reassembled.

The sequencers provide a digital genome. The digital genome is a reasonable and accurate representation of the individual's DNA. Laboratories that sequence the DNA can be Clinical Laboratory Improvement Amendments (CLIA) certified. Sequence analysis is often performed with redundancy and overlap to ensure accuracy (e.g., sequencing the DNA more than once and sequencing overlapping sections of the DNA and verifying the sequence). The sequenced information is then aligned and assembled. The sequenced genome is assembled using computer algorithms, resulting in a “digital” representation of the genome.

This wholly or partly sequenced digitized genome data can be stored in a removable digital storage medium 814 and transferred to the system 800 via the removable storage interface 808. In some cases, the digitized genome data can also be transferred to the system 800 via one or more communication networks such as the Internet, other wide area networks, local area networks, metropolitan networks and the like, using the network communication interfaces 806. In an aspect, the system 800 can include a genomic sequencing device (not shown in FIG. 8), thereby providing a stand-alone system that can prepare digital genome sequence data and process the prepared data in accordance with the methods described herein.

In this document, the term “digital storage medium” generally refers to a media format on which such digital information can be stored or saved. Examples of storage mediums include magnetic storage devices, such as internal hard drives, external hard drives, flash drives, CDs, DVDs, Blue Ray discs, tapes, and the like. However, in some cases, the term “digital storage medium” can also refer to the memory 804.

Also, in an embodiment, one or more genomes refer to the genomes of individuals or genomes from different tissues from the same individual. Accordingly, in an embodiment, a genome can include a genome from an individual being analyzed, one that is affected by a specific phenotype (e.g., disease) being analyzed or from a control individual. Additionally, the present invention can utilize genomes from different tissues from the same person, e.g. tumor tissue and healthy tissue.

Other source data 804A utilized in the embodiments of the present invention is the sequence of the reference genome. As described herein, the individual's digitized genome is compared to a reference genome (e.g. the Reference Human Genome, NCBI Build 36, www.ncbi.nlm.nih.gov/projects/genome/assembly/grc/human/index.shtml) and matches and differences between the reference genome and a set of individuals' genomes are recorded as a diff pattern as described herein. Similar to the digitized subject genome data, the reference genome data can also be transferred to the system 800 via the network communication interface 806 or via the removable storage interface 808. The entire source data transferred to the system 800 or at least some portions of the source data can be loaded into the memory 804 for processing.

Software 804B (e.g., executable instructions) described herein is also stored in the main memory 804. The software 804B, when executed using the processing unit 802, carries out the steps and/or processes described herein. In particular, the software 804B includes a diff-pattern module (e.g., instructions) that, for each genome in the segment, assigns a numerical value to a genotype at a single or multi base segment in an individual's genome to denote the presence of a match, a mismatch or no call of a nucleic acid base sequence of one or more chromosomal copies of the segment as compared to the nucleic acid base sequence at a corresponding reference genome segment. The diff pattern module then adds the assigned numerical values for all chromosomal copies of the segment in the individual genome to obtain a total numerical value. This creates a vector of total numerical values for the segment among the set of genomes, which provides a segment-specific pattern of genotype match/mismatch. In some embodiments, the diff-pattern module saves the total numerical value for the genotype in the genome and the null symbol of a no-call determination in a database 804C, which can also implemented in the memory 804. Also, other information or data described herein such as the segment-specific pattern of genotype match/mismatch can be stored in the database 804C.

As used herein, a “database” is a collection of two or more pieces of stored data in predetermined data index architectures. In an embodiment, the database 804C contains data associated with the site, for example, positional information (chromosome number, position on the chromosome), the nucleic acid base at the position for a genome, the nucleic acid base of the reference genome, diff-pattern data, and various other information about variants at that position. Data can be stored and indexed in a manner, and in a mode known in the art, or developed in the future. Examples of types of databases that store data and links described herein include MYSQL, SQL, and Oracle. Although illustrated as part of the system 800, the database 804C could be distributed among a plurality of computers, and portions of it could be located on the system 800 while other portions or copies are located on other computer systems.

The software 804B also includes a pattern filtering module (or instructions) for filtering one or more segments of two or more genomes based on a numerical segment-specific match/mismatch pattern between a set of genomes that were identified by the diff-pattern identification module (or instructions). In addition, the software 804B can also include a graphical user interface module (e.g., KnomeDISCOVERY SiteSeeker) that allows a user to define search criterions by using a set of predefined syntaxes or established regular expression syntaxes, or a combination thereof, to find sites with a specified diff-pattern.

The memory 804 can store other software and/or programs including an operating system for handling, various basic system services and for performing hardware dependent tasks as well as a network communication module (or instructions) for connecting the system 800 to other computer systems or networked devices via one or more communication networks described above. In an embodiment, the software 804B can be stored in a removable digital storage medium 814 and loaded into the memory 804 via the removable storage interface 808, or the software 804B can be implemented as a server-side application running on a remote server system (not shown).

In an embodiment, the source data 804A, the software 804B (e.g., diff-pattern identification module, pattern filtering module) and the database 804C are illustrated as stored in the memory 804 of the system 800. However, it should be understood that in some embodiments, the source data 804A, the software 804B and the database 804C can be implemented using multiple discrete memory units of the system 800 as appropriate. For example, the source data 804A can be stored temporarily in a high speed random access memory while the software 804B and the database 804C are implemented in an internal hard disk drive or a cloud storage drive. Further, it should be understood that functionality of the software 804B (or parts of the software) and the functionality of the database 804C can be implemented using multiple discrete systems. That is, in an embodiment, the functionality of the diff-pattern module, the pattern filtering module, and the database 804C, or any combination thereof, can be implemented using multiple discrete systems. For instance, the system 800 can be implemented in a server-client environment, wherein the diff-pattern identification module and the database are implemented on a remote server, while the pattern filtering module is implemented on a user client system. Furthermore, in another aspect, a user can access the software 804B and the database 804C from another system via a network using applications such as a web-browser configured to communicate with the software 804B and the database 804C of the system 800. The data can be stored physically together, or associated with one another.

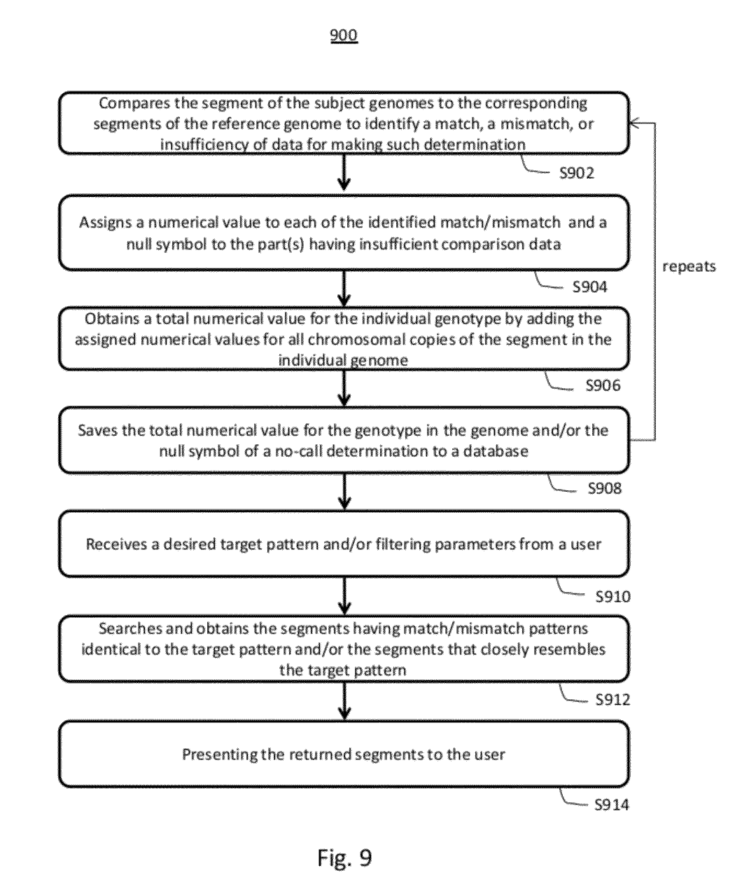

In yet another embodiment, the present invention relates to a non-transitory digital storage medium containing software (or a set of instructions) for performing the processes/steps of the methods described in various embodiments of the present invention. FIG. 9 is a flowchart illustrating the processes performed by the software according to an embodiment of the present invention. Various embodiments of the software and their routines will be described with reference to the exemplary system 800, but they are not necessarily limited to the structure of the system 800. In certain embodiments, some of the processes/steps described can be performed concurrently, in a different order, or can be omitted. The software can include additional processes/steps as appropriate.

Referring to FIG. 9, specifically S902, the software 804B compares the nucleic acid base sequence of each chromosomal copy of the segment of the subject genomes to the nucleic acid base sequence of the reference genome segment to determine the existence of a match or a mismatch, or a no call determination. As described above, the network communication interface 806 and/or the removable storage interface 808 can be utilized to obtain the source data 804A via a plurality of networks or via a plurality of removable digital storage mediums. The comparison of the nucleic acid base sequences can be performed by, for example, the processing unit 802.

In S904, the software 804B assigns a single-digit numerical value to each of the identified match or mismatch of each chromosomal copy of the segment in the genome depending on the determination made in the previous step. Also, a null symbol is assigned to each of the parts having insufficient comparison data. Here, the software 804B can be configured to assign a greater number (e.g., positive integer) to a mismatch than a number assigned to a match.

In S906, the assigned numerical values for all chromosomal copies of the segment in the individual genome are added to obtain a total numerical value for the genotype. In an embodiment, a match and a mismatch of the chromosomal copy of the segment of the genome to the corresponding nucleic acid base sequence of the reference genome segment, and a no-call are assigned with numerical values of “0”, “1”, and a null symbol “_”, respectively. In this setting, the total numerical value is not greater than “2”.

In S908, the software 804B saves the total numerical value for the genotype in the genome and/or the null symbol of a no-call determination for the segment of the genotype in the genome of the individual to the database 804C. As described above, the database 804C can also store additional data (or a subset of these data) including: a genome having one or more genotypes; a single or multi-base segment for the genotype, wherein the segment comprises a nucleic acid base tract of known length and position within a reference genome or the subject genome; and a nucleic acid base sequence of the reference genome segment that corresponds to the segment of the individuals' genome. In an embodiment, the software 804B is configured to repeat the processes/steps described above (S902, S904, S906, S908) for each genome in the segment in a set of genomes, creating a vector of total numerical values for the segment among the set of genomes, to obtain a segment-specific pattern of genotype match/mismatch.

In S910, a desired match/mismatch pattern (e.g., target pattern) is received from a user. Here, the I/O interface 810 can provide a suitable means for providing an interface for the user to specify the target pattern. For instance, an output device such as a display unit can present a graphical user interface to allow the user to set parameters (e.g., search queries) as shown in FIG. 7. Not only can the user search for a specific target pattern, but the user can also search for closely related patterns using a set of predefined syntaxes or a set of established regular expression syntaxes as described above. Entering target patterns and search syntaxes, and selecting other filtering parameters can be done using a plurality of input devices, such as a keyboard, a mouse, and a touch screen display.

In response to the user providing the target pattern and the filtering parameters, in S912, the segments having match/mismatch patterns identical to the target pattern and/or the segments having the match/mismatch pattern that closely resembles the target pattern are searched from the database 804C.

Furthermore, in S914, segments returned from the search are presented to the user via the I/O interface 810. Here, the degree of resemblance to the target pattern is defined by a distance metric equivalent or congruent to the following:

$${D}_{AB} = \text{?} \vert {A}_{j} - {B}_{j} \vert$$

$$\text{?} \text{indicates text missing or illegible when filed}$$

wherein pattern Aj is the value in the target pattern for the jth individual's genome, and pattern Bj is the value in the match/mismatch pattern for the segment in the jth individual genome, and n is the total number of individual genomes in the dataset.

The screenshots shown and described herein are examples of outputs that can be generated by the software 804B described herein. The outputs can be presented to a user using a plurality of output devices. An “output device” is defined as a medium for communicating the information and includes e.g., printouts, monitors showing screen outputs on computers or hand held/mobile devices, or data outputs to other applications such as email or spreadsheet, and the like. Accordingly, an output device can be any number of devices including a desktop computer, a workstation, a server, a distributed computing system, an embedded system, a stand-alone electronic device, a networked device, a portable computer, a mobile phone, a personal digital assistant (“PDA”), internet kiosk, or other type of a processor or a computer system. It is sufficient that the output devices allows for access or displays the diff pattern or a tool utilizing same. Output devices include those that are known in the art and those that are later developed

The relevant teachings of all the references, patents and/or patent applications cited herein are incorporated herein by reference in their entirety.

While this invention has been particularly shown and described with references to preferred embodiments thereof, it will be understood by those skilled in the art that various changes in form and details may be made therein without departing from the scope of the invention encompassed by the appended claims.

What is claimed is:

1) In a computer system, a method for assigning a numerical value to a genotype at a single- or multi-base segment in an individual's genome to denote the presence of a match or a mismatch of a nucleic acid base sequence of one or more chromosomal copies of the segment, as compared to the nucleic acid base sequence at a reference genome segment that corresponds to the segment of the individual's genome, wherein the method comprises:
a) comparing the nucleic acid base sequence of each chromosomal copy of the segment of the genome to determine the existence of a match to the nucleic acid base sequence of the reference genome segment, a mismatch to the nucleic acid base sequence of the reference segment, or a lack of a confident determination of match/mismatch; and
b) assigning a single-digit numerical value to the match or the mismatch of each chromosomal copy of the segment in the genome, wherein the numerical value assigned to a mismatch is greater than the numerical value of the match, to thereby obtain an assigned numerical value for each nucleic acid base of the genotype, and assigning a null symbol to a no-call;
c) summing the assigned numerical values of step b) for all chromosomal copies of the segment in the individual genome, to thereby obtain a total numerical value for the individual genotype, wherein the total numerical value is a single digit or a fixed number of digits;
d) saving, to a database, the total numerical value for the genotype in the genome or the null symbol of a no call determination, with or without a delimiter, for the segment of the genotype in the genome of the individual;
e) repeating steps a)-d) for each genome in the segment in a set of genomes to thereby create a vector of total numerical values for the segment among the set of genomes, to thereby obtain a segment-specific pattern of genotype match/mismatch between a set of genomes and the nucleic acid base sequence at the reference genome segment.

2) The method of claim 1, wherein the genotype comprises a combination of all alleles at a given site in a given genome.

3) The method of claim 1, further including at least two genomes, wherein the two genomes are from distinct tissues in the same individual, from distinct analyses of the same tissue in an individual, or from different individuals.

4) The method of claim 1, wherein a match of the chromosomal copy of the segment of the genome to the corresponding the nucleic acid base sequence of the reference genome segment is assigned a numerical value of 0 and a mismatch is assigned a numerical value of 1, and a no call is assigned a null symbol of _; and the total numerical value is not greater than 2.

5) In a computer system, a method of filtering one or more segments of two or more genomes, based on a numerical segment-specific match/mismatch pattern between a set of genomes, wherein the pattern is assigned according to the method of claim 1, the method comprises:
a) choosing a desired match/mismatch pattern to thereby obtain a target pattern;
b) comparing the target pattern to the match/mismatch pattern of each segment, to assess segments for which the target pattern is the same as the match/mismatch pattern, or segments for which the target pattern closely resembles the match/mismatch pattern;
c) displaying segments for which the target pattern is the same as the matching/mismatch pattern, or segments for which the target pattern closely resembles the match/mismatch pattern, wherein a target pattern that closely resembles the match/mismatch pattern is defined by a distance metric equivalent or congruent to the following:
$${D}_{AB} = \text{?} \vert {A}_{j} - {B}_{j} \vert$$
$$\text{?} \text{indicates text missing or illegible when filed}$$
wherein pattern Aj is the value in the target pattern for the jth individual's genome, and pattern Bj is the value in the match/mismatch pattern for the segment in the jth individual genome, and n is the total number of individual genomes in the dataset.

6) The method of claim 5, further including filtering variants based one or more additional criteria, wherein each criterion defines a characteristic associated with the genome segment or variants found therein.

7) The method of claim 6, wherein the criterion defining a characteristic associated with the genome segment or variants found therein includes information or status of publications about the variant, if the segment directly assists in encoding a functional molecule, if sequence variation in the segment or in a larger segment containing the segment is a priori thought to help govern the odds of a particular disease or other phenotype, and the like.

8) The method of claim 5, wherein a match/mismatch pattern representing a recessively acting variant is filtered.

9) The method of claim 5, wherein a match/mismatch pattern representing a dominantly acting variant is filtered.

10) The method of claim 5, wherein a match/mismatch pattern representing a loss of heterozygosity is filtered.

11) The method of claim 10, wherein a match/mismatch pattern represents a genome from a tumor, as compared to another genome from another tissue in the individual.

12) A computer system for assigning a numerical value to a genotype at a single or multi-base segment in an individual's genome to denote the presence of a match or a mismatch of a nucleic acid base sequence of one or more chromosomal copies of the segment, as compared to the nucleic acid base sequence at a reference genome segment that corresponds to the segment of in the individual's genome, wherein the computer apparatus comprises:
a) a source data comprising one or more genomes having one or more genotypes at a single or multi-base segment wherein the segment comprises a nucleic acid base sequence of one or more chromosomal copies, and the nucleic acid base sequence of the reference genome segment that corresponds to the segment of the individual's genome;
b) one or more software configured to receive and process the source data using one or more processing units, wherein the software having instructions for: comparing the nucleic acid base sequence of each chromosomal copy of the segment of the genome, to determine the existence of a match to the nucleic acid base sequence of the reference genome segment, mismatch to the nucleic acid base sequence of the reference segment, or cannot be confidently called; assigning a single digit numerical value to the match or the mismatch of each chromosomal copy of the segment in the genome, wherein the numerical value assigned to a mismatch is greater than the numerical value of the match, to thereby obtain an assigned numerical value for each nucleic acid base of the genotype, and to assign a null symbol to a no call determination; summing the assigned numerical values of each chromosomal copies of the segment in the genome, to thereby obtain a total numerical value for the genotype, wherein the total numerical value is a single digit or a fixed number of digits; and saving, to a database, the total numerical value for the genotype in the genome or the null symbol of a no call determination, with or without a delimiter, for the segment of the genotype in the genome of the individual.

13) The computer system of claim 12, wherein the software further comprises instructions used to repeat the steps for each genome in the segment to thereby create a vector of total numerical values for the segment among the set of genomes, to thereby obtain a segment-specific pattern of genotype match/mismatch between a set of genomes and the nucleic acid base sequence at the reference genome segment.

14) The computer system of claim 12, wherein the software assigns the numerical value so that a match of the chromosomal copy of the segment of the genome to the corresponding the nucleic acid base sequence of the reference genome segment is assigned a numerical value of 0 and a mismatch is assigned a numerical value of 1, and a no call is assigned a null symbol of _; and the total numerical value is not greater than 2.

15) The computer system of claim 12, further including an output device providing a display of the match/mismatch pattern.

16) The computer system of claim 12, wherein the database comprises;
a) data regarding the genome having one or more genotypes;
b) data regarding the single- or multi-base segment for the genotype, wherein the segment comprises a nucleic acid base tract of known length and position within a reference genome or the genome;
c) data regarding the nucleic acid base sequence of the reference genome segment that corresponds to the segment of the individual's genome; and
d) data regarding the total numerical value for the genotype, wherein the total numerical value is a single digit or a fixed number of digits.

17) The computer system of claim 16, wherein the database further comprise:
a) data from more than one genome; and
b) a vector of total numerical values for the segment among the set of genomes, to thereby obtain a segment-specific pattern of genotype match/mismatch between a set of genomes and the nucleic acid base sequence at the reference genome segment.

18) A computer system for obtaining a segment-specific pattern of genotype match/mismatch between a set of genomes and the nucleic acid base sequence at the reference genome segment, or for allowing a user to search for match/mismatch pattern that is identical to or closely resembling a target pattern, wherein the pattern is based on the match and mismatch between an individuals' studied genome and a reference genome, and wherein the computer system comprises:
a) one or more processing units; and
b) a memory storing a source data comprising one or more genomes having one or more genotypes at a single or multi-base segment wherein the segment comprises nucleic acid base sequences of one or more chromosomal copies of individuals' genomes and nucleic acid base sequences of corresponding segments in the reference genome; one or more software to be executed by the one or more processors to process the source data, wherein the software, for each genome in the segment, the one or more software having instructions for:
i) comparing the nucleic acid base sequence of each chromosomal copy of the segment of the genome to determine a match to the nucleic acid base sequence of the reference genome segment, a mismatch to the nucleic acid base sequence of the reference segment, or lack of a confident determination of match/mismatch;
ii) assigning a value to the match or the mismatch determined for each chromosomal copy of the segment in the genome, and a null symbol to a no call determination; and
iii) obtaining a total numerical value for the genotype by adding the assigned numerical values of each chromosomal copies of the segment in the genome.

19) The computer system of claim 18, wherein the software further comprises instructions for storing the total numerical value for the genotype in the genome and/or the null symbol of a no-call determination to a database.

20) The computer system of claim 19, wherein the software further comprises instructions for:
a) receiving a desired target pattern from a user;
b) searching for segments in the subject genomes having match/mismatch patterns identical to the target pattern and the segments that closely resembles the target pattern; and
c) presenting the obtained segments to the user, wherein the degree of resemblance to the target pattern is defined by a distance metric equivalent or congruent to the following:
$${D}_{AB} = \text{?} \vert {A}_{j} - {B}_{j} \vert$$
$$\text{?} \text{indicates text missing or illegible when filed}$$
wherein pattern Aj is the value in the target pattern for the jth individual's genome, and pattern Bj is the value in the match/mismatch pattern for the segment in the jth individual genome, and n is the total number of individual genomes in the dataset.

21) The computer system of claim 19, wherein the database comprises:
a) data regarding the genome having one or more genotypes;
b) data regarding the single or multi-base segment for the genotype, wherein the segment comprises a nucleic acid base tract of known length and position within a reference genome or the subject genome;
c) data regarding the nucleic acid base sequence of segments of the reference genome that corresponds to the segment of the subject genomes; and
d) data regarding the total numerical value for the genotype, wherein the total numerical value is a single digit or a fixed number of digits.

22) The computer system of claim 16, wherein the database further comprise:
a) data from more than one genome; and
b) data regarding a segment-specific pattern of genotype match/mismatch between the set of subject genomes and the nucleic acid base sequence at the reference genome segment.

23) A non-transitory computer readable storage medium storing one or more software to be executed by one or more processors, the one or more software having instructions for:
a) comparing the nucleic acid base sequence of each chromosomal copy of the segment of the genome to determine a match to the nucleic acid base sequence of the reference genome segment, a mismatch to the nucleic acid base sequence of the reference segment, or lack of a confident determination of match/mismatch;
b) assigning a value to the match or the mismatch determined for each chromosomal copy of the segment in the genome, and a null symbol to a no call determination; and
c) obtaining a total numerical value for the genotype by adding the assigned numerical values of each chromosomal copies of the segment in the genome.

24) The non-transitory computer readable storage medium of claim 23, wherein the software further comprises instructions for storing the total numerical value for the genotype in the genome and/or the null symbol of a no-call determination to a database.

25) The non-transitory computer readable storage medium of claim 23, wherein the software further comprises instructions for:
a) receiving a desired target pattern from a user;
b) searching for segments in the subject genomes having match/mismatch patterns identical to the target pattern and the segments that closely resembles the target pattern; and
c) presenting the obtained segments to the user, wherein the degree of resemblance to the target pattern is defined by a distance metric equivalent or congruent to the following:
$${D}_{AB} = \text{?} \vert {A}_{j} - {B}_{j} \vert$$
$$\text{?} \text{indicates text missing or illegible when filed}$$
wherein pattern Aj is the value in the target pattern for the jth individual's genome, and pattern Bj is the value in the match/mismatch pattern for the segment in the jth individual genome, and n is the total number of individual genomes in the dataset.
